(19) United States
(12) Patent Application Publication
(10) Pub. No.: US 2026/0362294 A1
(43) Pub. Date: Nov. 12, 2026

(54) ANTENNA IDENTIFIER IN REDUCED NEIGHBOR LIST

(71) Applicant: Cisco Technology, Inc., San Jose, CA (US)

(72) Inventors: Matthew Aaron Silverman, Shaker Heights, OH (US); Ardalan Alizadeh, Milpitas, CA (US); Peiman Amini, Fremont, CA (US); John Matthew Swartz, Lithia, FL (US)

(21) Appl. No.: 19/673,347

(22) Filed: May 11, 2026

Related U.S. Application Data
(60) Provisional application No. 63/803,642, filed on May 10, 2025.

(51) Int. Cl. H04W 48/08; H04W 16/28; H04W 48/18; H04W 84/12

(52) U.S. Cl. CPC H04W 48/08; H04W 16/28; H04W 48/18; H04W 84/12

(57) ABSTRACT

Neighbor lists with information for improved roaming operation, and particularly antenna identifiers (antenna IDs) in reduced neighbor lists for accurate roaming decisions may be provided. Proving antenna IDs for roaming includes determining, by an access point (AP), to provide a management frame to a client device for the client device to determine a roaming target. The AP generates the management frame, wherein the management frame comprises antenna ID values for a plurality of neighbor APs, each antenna ID value representing a beam direction from the AP toward a respective neighbor AP of the plurality of neighbor APs and an antenna ID value for the client device representing a beam direction from the AP toward the client device. The AP transmits the management frame to the client device for the client device to determine a target AP for roaming.

### RELATED APPLICATION

Under provisions of 35 U.S.C. § 119(e), Applicant claims the benefit of and priority to U.S. Provisional Application No. 63/803,642, filed May 10, 2025, the disclosure of which is incorporated herein by reference in its entirety.

### TECHNICAL FIELD

The present disclosure relates generally to providing neighbor lists with information for improved roaming operation, and particularly to providing antenna identifiers in reduced neighbor lists for accurate roaming decisions.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing antenna identifiers in RNRs and other management frames for accurate roaming decisions in accordance with aspects of the present disclosure.

FIG. 2 illustrates example positions of APs and a client device in the operating environment of FIG. 1 in accordance with aspects of the present disclosure.

FIG. 3 illustrates an example reduced neighbor report for providing antenna identifiers in accordance with aspects of the present disclosure.

FIG. 4 illustrates a signal process for roaming using antenna IDs in accordance with aspects of the present disclosure.

FIG. 5 is a flow diagram illustrating a method for providing antenna ID information in a management frame for roaming in accordance with aspects of the present disclosure.

FIG. 6 is a block diagram of a computing device in accordance with aspects of the present disclosure.

FIG. 7 is a block diagram of a communications device in accordance with aspects of the present disclosure.

### DETAILED DESCRIPTION

### Overview

Neighbor lists with information for improved roaming operation, and particularly antenna identifiers (antenna IDs) in reduced neighbor lists for accurate roaming decisions may be provided. Proving antenna IDs for roaming includes determining, by an access point (AP), to provide a management frame to a client device for the client device to determine a roaming target. The AP generates the management frame, wherein the management frame comprises antenna ID values for a plurality of neighbor APs, each antenna ID value representing a beam direction from the AP toward a respective neighbor AP of the plurality of neighbor APs and an antenna ID value for the client device representing a beam direction from the AP toward the client device. The AP transmits the management frame to the client device for the client device to determine a target AP for roaming.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Roaming in Wi-Fi networks occurs when a client device (e.g., a Station (STA)) transitions its connection from one Access Point (AP) to another, typically because the client device has moved outside the range of its serving AP or has identified another AP that can provide a better connection. Roaming decisions are primarily made by client devices based on Received Signal Strength Indicator (RSSI) measurements, supplemented by network recommendations from the serving AP regarding suitable neighbor APs.

A Reduced Neighbor Report (RNR) is a Wi-Fi feature that allows an AP to advertise information about neighbor APs within its beacon frames and probe responses so that clients can discover them more efficiently, particularly across different bands (e.g., 2.4 GHZ, 5 GHZ, 6 GHZ). For each reported neighbor AP, the RNR includes the operating channel and operating class, identifying the frequency band and specific channel on which the neighbor AP operates. The RNR also includes the Basic Service Set Identifier (BSSID), or a shortened form thereof, to uniquely identify the neighbor AP, and may optionally include Service Set Identifier (SSID) information or a Short SSID, the latter being commonly used for discovery in the 6 GHz band. Additional fields convey the Target Beacon Transmission Time (TBTT) offset, which indicates when the neighbor AP's next beacon is expected, as well as Basic Service Set (BSS) parameters and capability information describing the neighbor AP's supported features. The RNR may further include Multiple BSSID information for APs that host more than one virtual BSS, and co-location information indicating related APs operating across different bands. Together, these fields allow a client to quickly learn what nearby APs exist, on which channels they operate, and whether it should scan or roam to them, without requiring full active or passive scanning across every available channel.

However, the RNR does not include information related to the physical movement and position of a client device that would support accurate roaming decisions. A client may be moving toward a particular neighbor AP and, while the RNR may not indicate that neighbor AP as the preferred roaming target (e.g., because that AP currently presents a lower RSSI than another neighbor AP whose signal the client happens to be receiving well from behind, or because the neighbor AP in the direction of travel is on a different band whose signal characteristics make it appear less attractive at the moment of measurement) the AP toward which the client is physically moving is likely to be the best roaming candidate. As the client travels toward that AP, the signal quality will improve and the connection will become increasingly stable, whereas roaming to an AP that is behind or orthogonal to the client's direction of travel will require yet another roaming event shortly thereafter. Without directional context, the client cannot distinguish between these cases using only the information currently contained in the RNR.

The Institute of Electrical and Electronics Engineers (IEEE) 802.11ad is a high-performance wireless standard operating in the 60 GHz band, enabling what is referred to herein as Integrated Millimeter Wave (ImmW) operation. IEEE 802.11ay is a standard for ultra-high-speed, short-range wireless communication also operating in the 60 GHz band, extending and enhancing the 802.11ad protocol. Operation in the 60 GHz band and other millimeter wave bands (e.g., between 42 GHz and 71 GHZ) enables multi-gigabit data rates over short distances, which is particularly useful for low-latency applications such as virtual reality, augmented reality, wireless docking, and high-definition video streaming.

Because 60 GHz signals are highly directional and suffer significant path loss, devices operating in these bands do not transmit omnidirectionally as conventional sub-7 GHz Wi-Fi devices do. Instead, they use predefined directional antenna patterns, referred to as sectors, and steer radiated energy toward the intended receiver using antenna arrays. An antenna identifier (antenna ID, or AntID) identifies a particular directional beam pattern generated by an antenna array. Each antenna array supports many beam directions, and the antenna ID indicates the beam direction associated with that pattern. Antenna ID values range from 0 to 255 and map linearly to azimuthal angles spanning 0° to 360° around the device, such that each increment represents approximately 1.4° of angular separation. By convention, an antenna ID of 0 corresponds to a beam directed at 0° (e.g., directly to the right of the device given a standardized orientation), with values increasing counterclockwise through the full 360° circle. For example, an antenna ID of approximately 64 corresponds to a beam directed roughly 90° from the reference direction, antenna ID 128 corresponds to approximately 180°, and antenna ID 191 corresponds to approximately 270°. Because scanning every beam direction independently is computationally and temporally expensive, 60 GHz roaming relies heavily on neighbor awareness. The antenna ID framework is fundamental to how directional beamforming and neighbor discovery operate in 802.11ad and 802.11ay networks.

To improve roaming decisions, particularly in ImmW deployments, the embodiments described herein provide for a serving AP to include antenna ID information within RNRs or other management frames. Specifically, the serving AP performs beam training with each of its neighbor APs to determine, for each neighbor AP, the antenna ID value representing the beam direction from the serving AP toward that neighbor AP, as well as the antenna ID value representing the beam direction used by the serving AP toward the requesting client device. The serving AP includes these antenna ID values as an optional field within the RNR, such as within the TBTT Information Set or as a standalone field associated with the corresponding neighbor AP entry. In another embodiment, rather than reporting raw antenna ID values, the serving AP may report the angular delta or difference between the antenna ID it uses toward a given neighbor AP and the antenna ID it uses toward the requesting client, providing the client with a pre-computed directional offset. A client receiving an RNR augmented with antenna ID information and/or angular delta information can then use these values to determine the approximate positions of neighbor APs relative to itself and to the serving AP, infer its own direction of travel relative to the neighbor APs, and identify the neighbor AP most closely aligned with its direction of motion as the preferred roaming target.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, as used herein, reference to reading, writing, storing, buffering, and/or transferring data can include the entirety of the data, a portion of the data, a set of the data, and/or a subset of the data.

The terms “or,” “and/or,” “at least one of,” and “one or both of” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

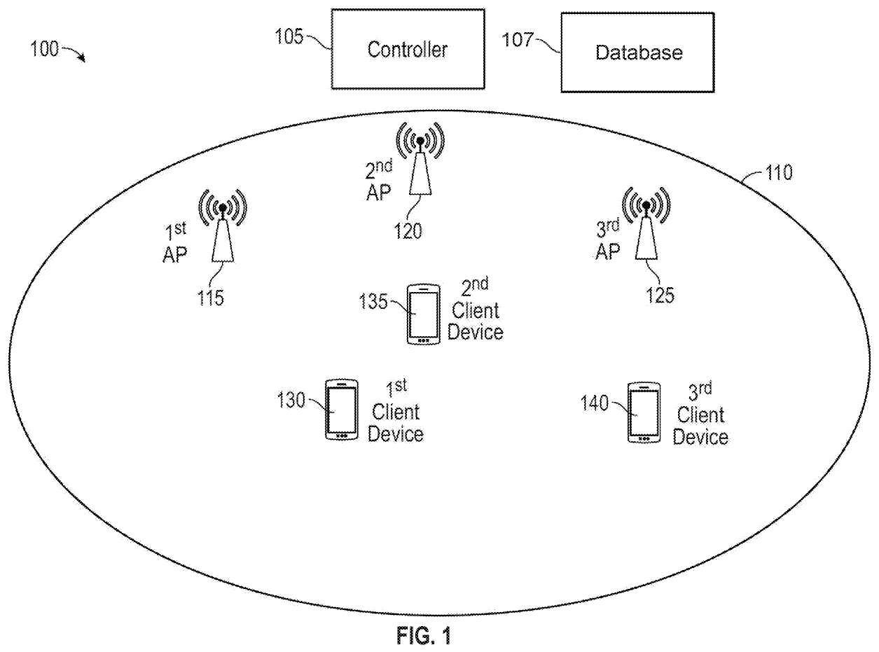

FIG. 1 illustrates an example operating environment 100 for providing antenna identifiers in RNRs and other management frames for accurate roaming decisions. As shown in FIG. 1, operating environment 100 comprises a controller 105, a database 107, and a coverage environment 110. Coverage environment 110 comprises a Wireless Local Area Network (WLAN) comprising a plurality of APs that provide wireless network access for client devices. In the illustrated embodiment, the APs comprise a first AP 115, a second AP 120, and a third AP 125, though the plurality of APs may comprise any number of APs in further embodiments.

The APs provide wireless network access to client devices (e.g., STAs) within coverage environment 110. In the illustrated embodiment, the client devices comprise a first client device 130, a second client device 135, and a third client device 140. A client device may be any device capable of wirelessly connecting to the network, such as a smartphone, a personal computer, a tablet, a mobile device, a telephone, a remote control device, a set-top box, a digital video recorder, an Internet-of-Things (IoT) device, a network computer, a router, a Virtual Reality (VR)/Augmented Reality (AR) device, or other similar microcomputer-based device. The APs and client devices may be compatible with specification standards such as the IEEE 802.11 specification standard, including IEEE 802.11ad, IEEE 802.11ay, and IEEE 802.11bq.

The APs and client devices may communicate using one or more wireless communication protocols, including IEEE 802.11-based protocols. The wireless communications may utilize ImmW frequency bands between 42 GHz and 71 GHZ, including for example communications at 60 GHz. In some implementations, the devices may additionally communicate using lower-frequency Wi-Fi bands, such as 2.4 GHz, 5 GHZ, or 6 GHz bands, for broader coverage and reliability alongside the high-speed, short-range ImmW transmissions.

The controller 105 comprises a WLAN controller that may provision and control the coverage environment 110, including permitting the first client device 130, the second client device 135, and the third client device 140 to join the coverage environment 110. In some embodiments, the controller 105 is implemented as a Digital Network Architecture Center (DNAC) controller (e.g., a Software-Defined Network (SDN) controller) that configures the APs to support providing antenna ID information in RNRs and other management frames for roaming as described herein.

Before antenna ID information can be included in RNRs or other management frames provided to client devices, the APs determine their respective antenna ID values to each of their neighbor APs through a beam training process. In 802.11ad/ay networks, Beam Refinement Protocol (BRP) training is conventionally performed only between APs and their associated client devices. In the embodiments described herein, BRP training is extended to be performed between neighbor APs, so that each AP can determine the antenna ID that best directs its beam toward each of its neighbor APs. In one embodiment, this inter-AP beam training is triggered by the sub-7 GHz radios of the respective APs: once sub-7 GHz neighbor discovery reveals that neighbor APs also support ImmW operation, the sub-7 GHz radio coordinates a beam training session between the APs on their ImmW channels, during which the APs determine their best mutual antenna IDs. In another embodiment, a serving AP receives a 60 GHz beacon report from a client device, compares the neighbor APs identified in that beacon report against its own 60 GHz neighbor list, and triggers BRP training between the APs that appear in both lists, thereby determining the best antenna ID for each matching neighbor AP. Because APs are generally stationary, the resulting antenna ID values are stable over time and need not be re-determined except when a change to the operating environment 100 occurs, such as the addition of a new AP, removal of an existing AP, or physical relocation of an existing AP.

The database 107 stores the antenna ID values obtained through inter-AP beam training so they are available for future use without requiring repeated training. For example, the database 107 stores the antenna ID of the first AP 115 directed toward the second AP 120 (AntID(1,2)), the first AP 115 directed toward the third AP 125 (AntID(1,3)), the second AP 120 directed toward the first AP 115 (AntID(2,1)), the second AP 120 directed toward the third AP 125 (AntID(2,3)), the third AP 125 directed toward the first AP 115 (AntID(3,1), and the third AP 125 directed toward the second AP 120 (AntID(3,2)). In some embodiments, APs store their respective antenna ID values locally rather than in a centralized database 107, or in an alternative storage location accessible to the AP.

When an AP prepares to send an RNR, probe response, or other management frame that includes antenna ID information, the AP retrieves the relevant stored antenna ID values for its neighbor APs from the database 107 or from local storage. For example, the first AP 115 retrieves its antenna ID values toward each of its neighbor APs: AntID(1,2) toward the second AP 120 and AntID(1,3) toward the third AP 125. The first AP 115 additionally determines the current antenna ID it is using to communicate with the requesting client device (AntID(1,C)), which reflects the beam direction from the first AP 115 toward the client device at its current position. The first AP 115 then includes these antenna ID values in the RNR or other management frame transmitted to the client device.

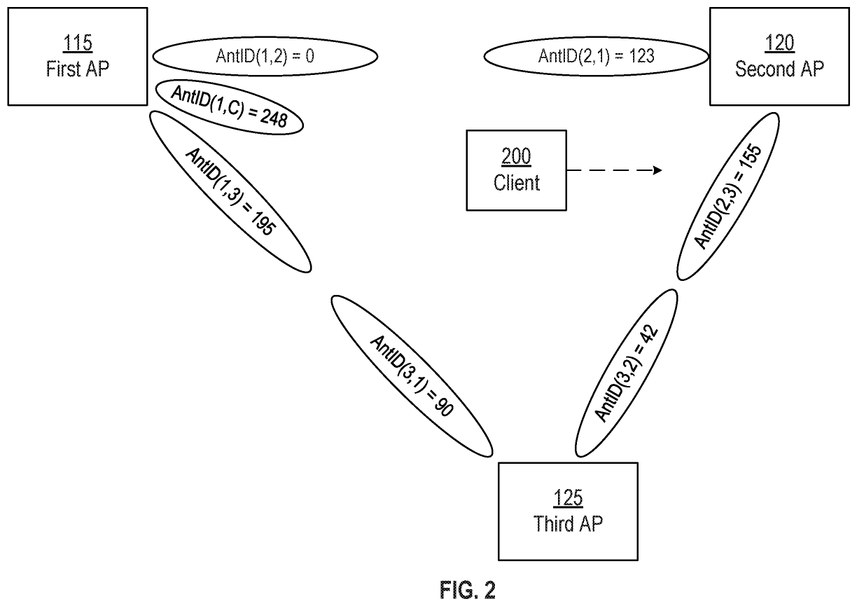

In some embodiments, the client device receives the management frame containing the antenna ID values and uses them to determine which neighbor AP is the best roaming candidate. As described in greater detail in connection with FIG. 2, the client device performs a delta determination to compute an angular difference between the direction of each candidate neighbor AP and the direction of the client device, both as seen from the serving AP. A smaller angular difference indicates that the client device is positioned more directly in line with, and therefore likely closer to or moving toward, that particular neighbor AP from the serving AP's perspective, making it a more suitable roaming target. In other embodiments, the serving AP performs the delta determination itself and includes the resulting angular difference values in the frame it sends to the client device, in addition to or instead of the raw antenna ID values. In those embodiments, the client device uses the pre-computed angular differences provided by the serving AP to select a roaming target without performing the calculation itself.

The operating environment 100 is provided solely as an illustrative example. In various implementations, the operating environment 100 may include additional or fewer controllers, APs, client devices, databases, network devices, communication links, or coverage relationships than those illustrated in FIG. 1. Further, although certain example components are illustrated as separate entities, some functions may be combined, distributed, virtualized, centralized, or otherwise implemented in different configurations.

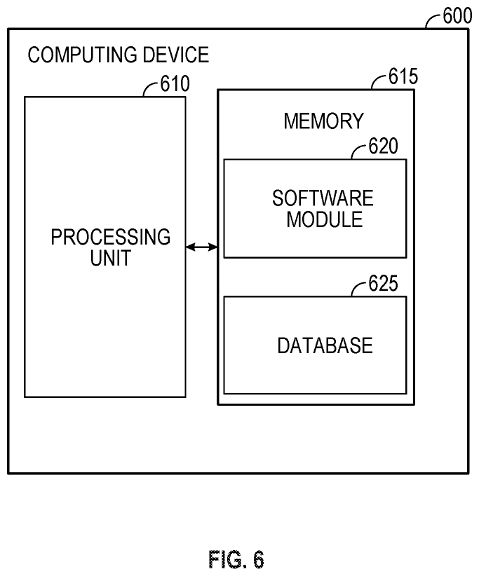

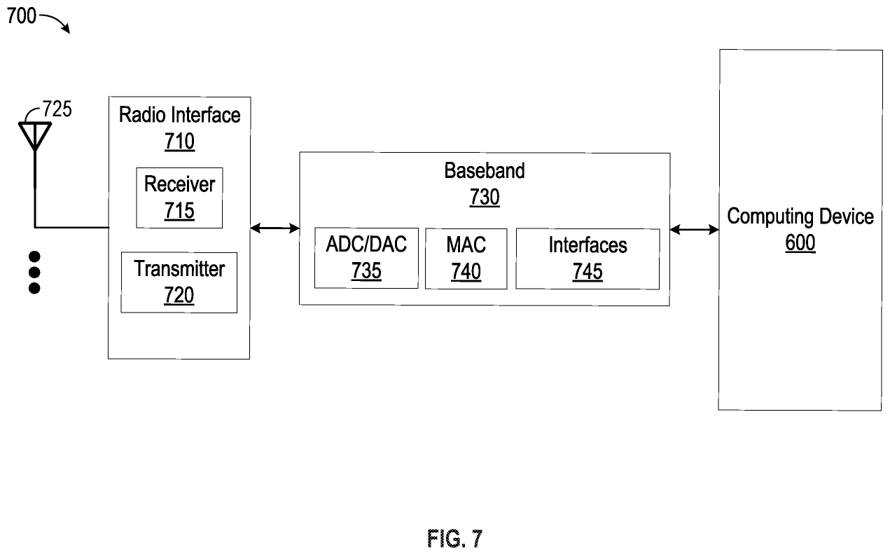

The elements described above of the operating environment 100 (e.g., the controller 105, the database 107. the first AP 115, the second AP 120, the third AP 125, the first client device 130, the second client device 135, the third client device 140, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 6 and 7, the elements of the operating environment 100 may be practiced in a computing device 600 and/or communications device 700.

FIG. 2 illustrates example positions of APs and a client device 200 which may correspond to, for example, the first client device 130, the second client device 135, or the third client device 140 of FIG. 1 within the operating environment 100. FIG. 2 further illustrates how the client device 200 uses antenna ID values included in an RNR or other management frame received from a serving AP to identify the best neighbor AP roaming candidate.

In the illustrated embodiment, the antenna ID values determined through inter-AP beam training are as follows: the antenna ID of the first AP 115 directed toward the second AP 120 (AntID(1,2)) is 0; the antenna ID of the first AP 115 directed toward the third AP 125 (AntID(1,3)) is 195; the antenna ID of the second AP 120 directed toward the first AP 115 (AntID(2,1)) is 123; the antenna ID of the second AP 120 directed toward the third AP 125 (AntID(2,3)) is 155; the antenna ID of the third AP 125 directed toward the first AP 115 (AntID(3,1)) is 90; and the antenna ID of the third AP 125 directed toward the second AP 120 (AntID(3,2)) is 42. These values may be determined once through beam training and stored in the database 107 or in local storage for use in subsequent roaming decisions, as described in connection with FIG. 1.

As shown in FIG. 2, the client device 200 is currently associated with the first AP 115, and the first AP 115 is using antenna ID 248 (AntID(1,C)=248) to communicate with the client device 200, indicating the beam direction from the first AP 115 toward the client device's current position. In response to an indication that the client device 200 should roam (e.g., upon receiving a neighbor report request from the client device 200 or upon detecting connection degradation based on RSSI measurements), the first AP 115 transmits an RNR or other management frame to the client device 200 containing the relevant antenna ID values: AntID(1,2)=0 for the second AP 120, AntID(1,3)=195 for the third AP 125, and AntID(1,C)=248 for the client device 200. In other embodiments, as noted above, the first AP 115 performs the delta determination described below and transmits the resulting angular differences to the client device 200 in the frame rather than, or in addition to, the raw antenna ID values.

Upon receiving the antenna ID values, the client device 200 performs a delta determination to compute an angular difference between each candidate neighbor AP and the client device's position, as seen from the first AP 115. The delta determination is performed using equations (1) and (2):

$$Δ AngRa w ( C , NAP ) = ( AntID ( SAP , NAP ) - AntID ( SAP , C ) ) \times \frac{360}{255} \qquad ( 1 )$$

$$Δ AngUnwrap ( C , NAP ) = min ( \vert Δ AngRaw ( C , NAP ) \vert , \vert 360 - \vert Δ AngRaw ( C , NAP ) \vert \vert ) \qquad ( 2 )$$

In equations (1) and (2), C represents the client device, SAP represents the serving AP, and NAP represents a candidate neighbor AP. Equation (1) computes a raw angular delta by subtracting the antenna ID value of the serving AP directed toward the client device (AntID(SAP, C)) from the antenna ID value of the serving AP directed toward the candidate neighbor AP (AntID(SAP, NAP)), and multiplying the result by 360/255 to convert the difference to degrees. The result represents the raw angular separation, from the serving AP's perspective, between the direction of the candidate neighbor AP and the direction of the client device.

Equation (2) computes an unwrapped angular delta to account for wraparound when the raw angular difference crosses the 0°/360° boundary. Equation (2) returns the minimum of the absolute value of the raw angular delta from equation (1) and the value of 360 minus that absolute value, yielding the true minimum angular separation regardless of wraparound. The client device performs the delta determination of equations (1) and (2) for each candidate neighbor AP included in the received frame and selects the neighbor AP with the smallest unwrapped angular delta as the preferred roaming target. A smaller unwrapped angular delta indicates that the client device is positioned more directly in line with the candidate neighbor AP as seen from the serving AP (e.g., the serving AP's beam toward the client device and its beam toward that neighbor AP are pointing in nearly the same direction), which indicates that the client device is in closer spatial proximity to that neighbor AP and that it represents a better roaming candidate.

Applying equations (1) and (2) to the values illustrated in FIG. 2: for the second AP 120, equation (1) yields (0-248)×360/255≈−350.1°, and equation (2) yields min (350.1, |360−350.1|)=9.9°. For the third AP 125, equation (1) yields (195-248)×360/255≈−74.8°, and equation (2) yields min (74.8, |360−74.8|)≈74.8°. The smaller unwrapped delta of 9.9° for the second AP 120 indicates that the client device 200 is positioned more closely in line with the second AP 120 as seen from the first AP 115, making the second AP 120 the preferred roaming candidate over the third AP 125.

In some embodiments, the delta determination can also be used to track the movement of the client device 200. As shown in FIG. 2, the client device 200 may be moving toward the second AP 120. Rather than providing a single RNR or management frame, the serving first AP 115 may transmit a sequence of RNRs or other management frames at successive points in time, allowing the client device 200 to observe how the antenna ID to the client device (AntID(1,C)) changes over time and thereby infer the direction of its own movement relative to the neighbor APs. For example, as the client device 200 moves toward the second AP 120, the angular difference between AntID(1,2) and AntID(1,C) decreases across successive frames, confirming that the client device 200 is approaching the second AP 120 and further supporting it as the roaming target. Conversely, if the client device 200 were instead moving toward the third AP 125, the angular difference between AntID(1,2) and AntID(1, C) would increase across successive frames while the angular difference between AntID(1,3) and AntID(1,C) would decrease, signaling that the third AP 125 may be a better roaming candidate despite potentially being farther away at the moment of the first measurement. In such cases, the client device 200 may factor in estimated trajectory (e.g., whether the client device 200 is expected to continue toward the third AP 125 or to reverse direction toward the second AP 120) or other contextual information to select the most appropriate roaming target.

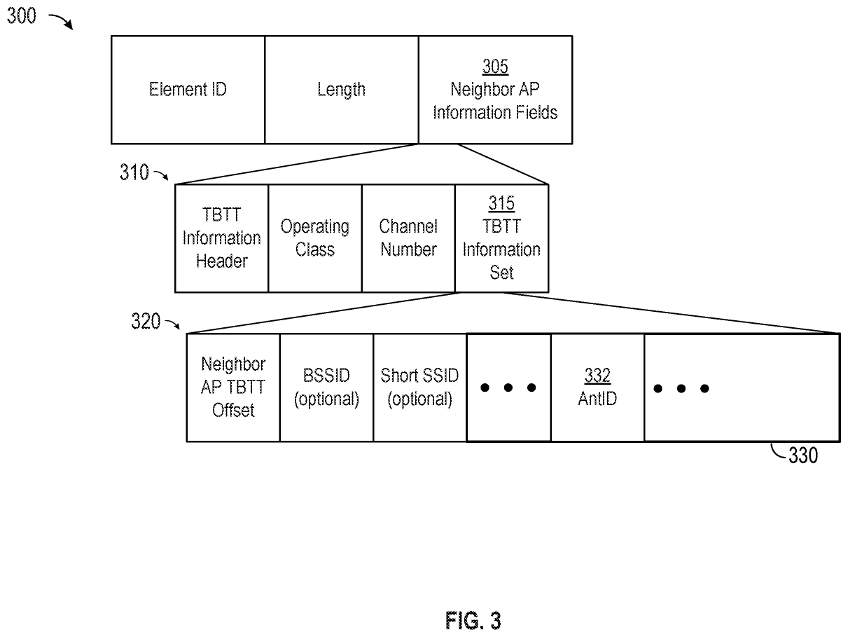

FIG. 3 illustrates an example RNR 300. The RNR 300 includes an element ID field, a length field, and neighbor AP information fields 305 comprising one or more AP information fields 310. Each AP information field 310 includes, among other fields, a TBTT Information Set field 315 comprising one or more TBTT Information fields 320. In the illustrated embodiment, a TBTT Information field 320 includes, among other fields, optional fields 330 comprising an antenna ID field 332. In example implementations, the antenna ID field 332 contains the antenna ID value of the serving AP directed toward the respective neighbor AP, such as the AntID(1,2) for the second AP 120 as a neighbor entry within the RNR of the first AP 115. Another AP information field 310 for the third AP 125 includes the AntID(1,3) in the respective antenna ID field 332 as neighbor entry within the first AP 115's RNR. In further implementations, the antenna ID field 332 instead contains the pre-computed delta determination value (e.g., the unwrapped angular difference returned by equation (2)), so that the client device can directly use the value for roaming candidate selection without performing the calculation itself.

While FIG. 3 illustrates the antenna ID field 332 as residing within the optional fields 330 of a TBTT Information field 320, the antenna ID field 332 may alternatively be implemented as a standalone field appended within the RNR 300. In a further embodiment, the antenna ID information may be provided in a probe response or other management frame within its tagged parameters (e.g., in response to a probe request from a client device, in which case the serving AP may include the antenna ID value for each listed neighbor AP or provide the pre-computed delta between the antenna ID used for that neighbor AP and the antenna ID the serving AP is using for the requesting client device). Regardless of where the antenna ID field 332 appears within the frame, it associates the antenna ID or angular delta value with the corresponding neighbor AP's BSSID and/or SSID, allowing the client device to unambiguously match each antenna ID value to its respective neighbor AP entry. While the antenna ID information described herein is primarily targeted at ImmW operation due to the well-defined beam directivity of 60 GHz antenna arrays, the approach may be generalized to other frequency bands, including sub-7 GHz bands, so that antenna ID or angular information may also be included in entries for sub-7 GHz neighbor APs in embodiments where such information is available and useful.

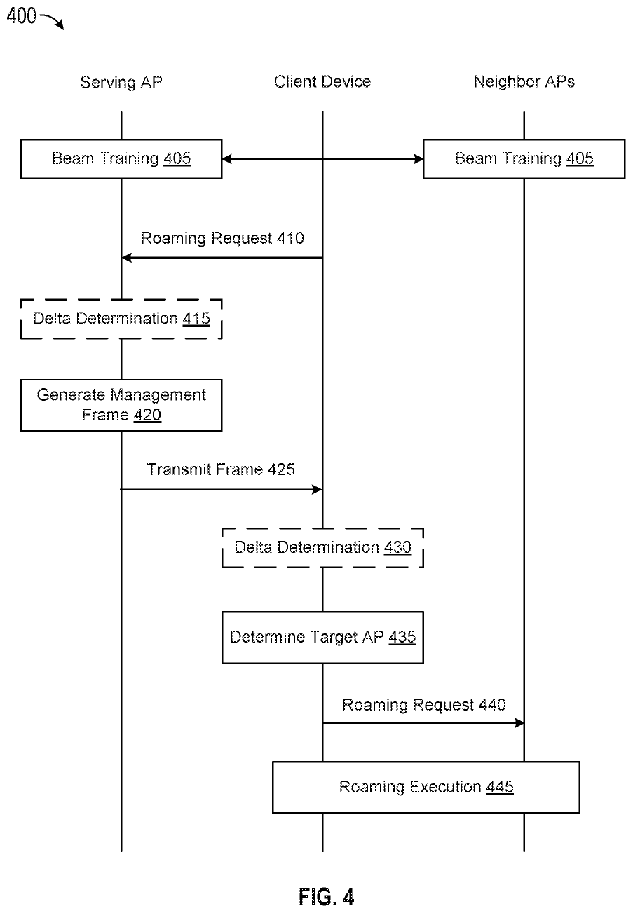

FIG. 4 illustrates a signal process 400 for roaming using antenna IDs. The signal process 400 is performed among a serving AP (e.g., the first AP 115 as described with respect to FIGS. 1 and 2), a client device (e.g., the first client device 130, the second client device 135, the third client device 140, or the client device 200), and one or more neighbor APs (e.g., the second AP 120 and the third AP 125).

The signal process 400 begins with beam training between the serving AP and its neighbor APs in operation 405. As described above with respect to FIG. 1, the beam training may be triggered by sub-7 GHz neighbor discovery upon determining that neighbor APs support ImmW operation, or may be triggered based on a 60 GHz beacon report received from a client device. Through the beam training process, the serving AP and each neighbor AP determine the antenna ID values that best direct their respective beams toward one another. These antenna ID values are stored in the database 107 or in local storage for use in subsequent roaming decisions. Because APs are generally stationary, operation 405 is performed once at initial deployment or following a change to the operating environment, such as the addition, removal, or relocation of an AP, rather than on a per-roaming-event basis.

In operation 410, the client device sends a roaming-related request to the serving AP (e.g., a neighbor report request) to solicit information about candidate neighbor APs. In other embodiments, the serving AP may determine to transmit a management frame including antenna ID information and/or delta determination information without an explicit request from the client device. For example, the serving AP may proactively transmit the frame upon detecting degradation in the client device's connection quality based on RSSI measurements, upon the client device's signal falling below a threshold, or upon the serving AP otherwise determining that the client device may benefit from roaming.

In optional operation 415, the serving AP performs the delta determination for one or more candidate neighbor APs (e.g., using equations (1) and (2) described above). In some embodiments, the serving AP computes and includes delta determination information for every neighbor AP in its neighbor list. In other embodiments, the serving AP computes and includes delta determination information for a subset of neighbor APs, such as a predetermined number of neighbor APs (e.g., three or five) that are identified as initial candidates based on other criteria. This criteria can include RSSI values, information provided in the client device's roaming request, or historical data indicating which neighbor APs are most commonly selected as roaming targets from the serving AP. Operation 415 is optional because, in some embodiments, the serving AP omits the delta determination and instead includes raw antenna ID values in the management frame, leaving the delta determination to be performed by the client device as described below.

In operation 420, the serving AP generates a management frame containing antenna ID values and/or delta determination information for the candidate neighbor APs. The management frame is an RNR 300 in example implementations, as illustrated in FIG. 3, though the information may alternatively be provided in a probe response or other management frame as described above. In operation 425, the serving AP transmits the management frame to the client device.

In optional operation 430, the client device performs the delta determination for the neighbor APs for which antenna ID values were included in the received management frame. The client device may perform the delta determination for all such neighbor APs or for a subset that the client device has independently identified as likely roaming candidates. Operation 430 is performed when the management frame includes raw antenna ID values but not pre-computed delta determination information (e.g., when the serving AP did not perform operation 415). If the management frame already includes delta determination information from the serving AP, the client device may omit operation 430 and use the pre-computed values directly.

In operation 435, the client device determines the target AP to roam to from among the candidate neighbor APs. The client device selects the neighbor AP with the smallest unwrapped angular difference, as determined either through the client device's own delta determination in operation 430 or from the pre-computed values received from the serving AP in operation 425, as the preferred roaming target because that neighbor AP is most closely aligned with the client device's position as seen from the serving AP.

In operation 440, the client device sends a roaming request to the target AP (e.g., the second AP 120 in the scenario illustrated in FIG. 2). In operation 445, the client device and the target AP execute the roaming procedure. If roaming is unsuccessful, such as because the target AP is unreachable or declines the association, the client device may send a roaming request to an alternate target AP. For example, the alternate target AP may be the neighbor AP with the next smallest unwrapped angular difference. The client device can then perform the roaming execution with that alternate AP.

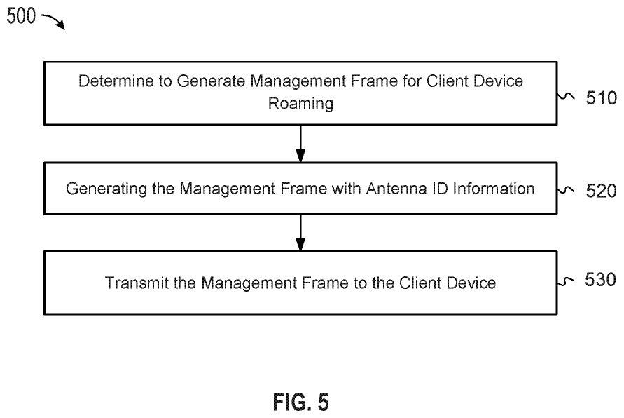

FIG. 5 is a flow diagram illustrating a method 500 performed by an AP for providing antenna ID information in a management frame for roaming. The method 500 is described with reference to the signal process 400 of FIG. 4 and the operating environment 100 of FIG. 1 in example implementations.

In stage 510, the AP determines to provide a management frame to a client device for the client device to determine a roaming target. In some embodiments, the AP determines to provide the management frame in response to receiving a neighbor report request from the client device. In other embodiments, the AP determines to provide the management frame proactively upon detecting that the client device's connection quality has degraded, for example based on RSSI measurements falling below a threshold, or upon otherwise determining that the client device may benefit from roaming information. In some embodiments, the management frame includes antenna ID information for all neighbor APs in the AP's neighbor list. In other embodiments, the management frame includes antenna ID information for a subset of the neighbor APs, such as a predetermined number of neighbor APs selected based on signal strength measurements, information included in a request received from the client device, or historical data indicating neighbor APs most frequently selected as roaming targets from the AP.

In stage 520, the AP generates the management frame. The management frame comprises antenna ID values for a plurality of neighbor APs, each antenna ID value representing a beam direction from the AP toward a respective neighbor AP, and an antenna ID value for the client device representing the beam direction from the AP toward the client device at its current position. In example implementations, the antenna ID values are values ranging from 0 to 255 representing beam directions spanning 0° to 360° around the AP, where each increment represents approximately 1.4° of angular separation.

In some embodiments, the AP determines the antenna ID values for the plurality of neighbor APs by performing beam training with the plurality of neighbor APs prior to generating the management frame, as described with respect to operation 405 of FIG. 4. In example implementations, performing the beam training is triggered by determining that the plurality of neighbor APs support ImmW operation via sub-7 GHz neighbor discovery. In other example implementations, performing the beam training is triggered by identifying that the plurality of neighbor APs are present in both an ImmW beacon report received from a second client device and an ImmW neighbor list maintained by the AP. The antenna ID values obtained through beam training may be stored in the database 107 or in local storage and retrieved when generating the management frame, as described with respect to FIG. 1.

In some embodiments, the AP additionally performs a delta determination prior to generating the management frame, computing angular differences between the beam directions from the AP toward the plurality of neighbor APs and the beam direction from the AP toward the client device, as described with respect to equations (1) and (2) above. In such embodiments, the management frame includes the computed angular differences in addition to or instead of the raw antenna ID values, so that the client device can use the pre-computed angular differences directly to select a roaming target without performing the calculation itself. In some embodiments, the management frame is a RNR 300 as illustrated in FIG. 3. In such embodiments, the RNR comprises AP information fields for the plurality of neighbor APs, each AP information field for a respective neighbor AP including an antenna ID field carrying the antenna ID value for that neighbor AP, as described with respect to FIG. 3. In further embodiments, the management frame is a probe response or other management frame comprising the antenna ID values or angular differences in tagged parameters.

In stage 530, the AP transmits the management frame to the client device. In some embodiments, the client device uses the antenna ID values or angular differences received in the management frame to identify a target neighbor AP for roaming by determining which neighbor AP has the smallest angular difference between the beam direction from the AP toward that neighbor AP and the beam direction from the AP toward the client device, as described with respect to FIG. 2. In other embodiments, as described above, the AP has already computed the angular differences and included them in the management frame, and the client device uses those pre-computed values directly to select the target neighbor AP with the smallest angular difference.

In some embodiments, the AP transmits a sequence of management frames to the client device at successive points in time, each management frame comprising the antenna ID values for the plurality of neighbor APs and a respective antenna ID value for the client device reflecting the current beam direction from the AP toward the client device at the time of transmission. The client device may use the sequence of management frames to observe changes in its antenna ID value over time, thereby tracking its direction of movement relative to the neighbor APs and further refining its roaming target selection, as described with respect to FIG. 2.

FIG. 6 is a block diagram of a computing device 600. As shown in FIG. 6, computing device 600 may include a processing unit 610 and a memory unit 615. Memory unit 615 may include a software module 620 and a database 625. While executing on processing unit 610, software module 620 may perform, for example, processes for providing neighbor lists with information for improved roaming operation, and particularly to providing antenna ID in reduced neighbor lists for accurate roaming decisions. Computing device 600, for example, may provide an operating environment for the controller 105, the database 107. the first AP 115, the second AP 120, the third AP 125, the first client device 130, the second client device 135, the third client device 140, and the like. The controller 105, the database 107. the first AP 115, the second AP 120, the third AP 125, the first client device 130, the second client device 135, the third client device 140, and the like may operate in other environments and are not limited to computing device 600.

Computing device 600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a SOC where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 600 on the single integrated circuit (chip).

FIG. 7 illustrates an implementation of a communications device 700 that may implement one or more of the controller 105, the database 107. the first AP 115, the second AP 120, the third AP 125, the first client device 130, the second client device 135, the third client device 140, etc. In various implementations, the communications device 700 may comprise a logic circuit. The logic circuit may include physical circuits to perform operations described for one or more of the controller 105, the database 107. the first AP 115, the second AP 120, the third AP 125, the first client device 130, the second client device 135, the third client device 140, etc., for example. As shown in FIG. 7, the communications device 700 may include one or more of, but is not limited to, a radio interface 710, baseband circuitry 730, and/or the computing device 600.

The communications device 700 may implement some or all of the structures and/or operations for the controller 105, the database 107. the first AP 115, the second AP 120, the third AP 125, the first client device 130, the second client device 135, the third client device 140, etc., storage medium, and logic circuit in a single computing entity, such as entirely within a single device. Alternatively, the communications device 700 may distribute portions of the structure and/or operations using a distributed system architecture, such as a client station server architecture, a peer-to-peer architecture, a master-slave architecture, etc.

A radio interface 710, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 710 may include, for example, a receiver 715 and/or a transmitter 720. The radio interface 710 may include bias controls, a crystal oscillator, and/or one or more antennas 725. In additional or alternative configurations, the radio interface 710 may use oscillators and/or one or more filters, as desired.

The baseband circuitry 730 may communicate with the radio interface 710 to process, receive, and/or transmit signals and may include, for example, an Analog-To-Digital Converter (ADC) for down converting received signals with a Digital-To-Analog Converter (DAC) 735 for up converting signals for transmission. Further, the baseband circuitry 730 may include a baseband or Physical (PHY) layer processing circuit for the PHY link layer processing of respective receive/transmit signals. Baseband circuitry 730 may include, for example, a Media Access Control (MAC) processing circuit 740 for MAC/data link layer processing. Baseband circuitry 730 may include a memory controller for communicating with MAC processing circuit 740 and/or a computing device 600, for example, via one or more interfaces 745.

In some configurations, PHY processing circuit may include a frame construction and/or detection module, in combination with additional circuitry such as a buffer memory, to construct and/or deconstruct communication frames. Alternatively or in addition, MAC processing circuit 740 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method comprising:
determining, by an access point (AP), to provide a management frame to a client device for the client device to determine a roaming target;
generating, by the AP, the management frame, wherein the management frame comprises:
antenna ID values for a plurality of neighbor APs, each antenna ID value representing a beam direction from the AP toward a respective neighbor AP of the plurality of neighbor APs, and
an antenna ID value for the client device representing a beam direction from the AP toward the client device; and
transmitting, by the AP, the management frame to the client device.

2. The method of claim 1, further comprising:
determining the antenna ID values for the plurality of neighbor APs by performing beam training with the plurality of neighbor APs.

3. The method of claim 2, wherein performing the beam training is triggered by:
determining the plurality of neighbor APs support integrated millimeter wave (ImmW) operation via neighbor discovery; or
identifying the plurality of neighbor APs are present in a ImmW beacon report from a second client device and a ImmW beacon report of the AP.

4. The method of claim 1, further comprising:
determining angular differences between the beam directions from the AP toward the plurality of neighbor APs and the beam direction from the AP to the client device; and
wherein the management frame includes the angular differences.

5. The method of claim 1, wherein the client device is configured to determine a target neighbor AP of the plurality of neighbor APs for roaming by determining the target neighbor AP has a smallest angular difference between the beam directions from the AP toward the plurality of neighbor APs and the beam direction from the AP to the client device.

6. The method of claim 1, wherein the management frame is a reduced neighbor report (RNR).

7. The method of claim 6, wherein the RNR comprises AP information fields for the plurality of neighbor APs, each AP information field for a respective AP of the plurality of neighbor APs including an antenna ID field carrying the antenna ID value of the respective AP.

8. A system comprising:
a memory storage; and
a processing unit coupled to the memory storage, wherein the processing unit is operative to:
determine to provide a management frame to a client device for the client device to determine a roaming target;
generate the management frame, wherein the management frame comprises:
antenna ID values for a plurality of neighbor APs, each antenna ID value representing a beam direction from a serving AP toward a respective neighbor AP of the plurality of neighbor APs, and
an antenna ID value for the client device representing a beam direction from the serving AP toward the client device; and
transmit the management frame to the client device.

9. The system of claim 8, wherein the processing unit is further operative to:
determine the antenna ID values for the plurality of neighbor APs by performing beam training with the plurality of neighbor APs.

10. The system of claim 9, wherein to perform the beam training is triggered by:
determining the plurality of neighbor APs support integrated millimeter wave (ImmW) operation via neighbor discovery; or
identifying the plurality of neighbor APs are present in a ImmW beacon report from a second client device and a ImmW beacon report of the serving AP.

11. The system of claim 8, wherein the processing unit is further operative to:
determine angular differences between the beam directions from the serving AP toward the plurality of neighbor APs and the beam direction from the serving AP to the client device; and
wherein the management frame includes the angular differences.

12. The system of claim 8, wherein the client device is configured to determine a target neighbor AP of the plurality of neighbor APs for roaming by determining the target neighbor AP has a smallest angular difference between the beam directions from the serving AP toward the plurality of neighbor APs and the beam direction from the serving AP to the client device.

13. The system of claim 8, wherein the management frame is a reduced neighbor report (RNR).

14. The system of claim 13, wherein the RNR comprises AP information fields for the plurality of neighbor APs, each AP information field for a respective AP of the plurality of neighbor APs including an antenna ID field carrying the antenna ID value of the respective AP.

15. A non-transitory computer-readable medium that stores a set of instructions which when executed by a processing unit, cause the processing unit to perform a method comprising:
determining to provide a management frame to a client device for the client device to determine a roaming target;
generating the management frame, wherein the management frame comprises:
antenna ID values for a plurality of neighbor APs, each antenna ID value representing a beam direction from a serving AP toward a respective neighbor AP of the plurality of neighbor APs, and
an antenna ID value for the client device representing a beam direction from the serving AP toward the client device; and
transmitting the management frame to the client device.

16. The non-transitory computer-readable medium of claim 15, the method executed by the set of instructions further comprising:
determining the antenna ID values for the plurality of neighbor APs by performing beam training with the plurality of neighbor APs.

17. The non-transitory computer-readable medium of claim 16, herein performing the beam training is triggered by:
determining the plurality of neighbor APs support integrated millimeter wave (ImmW) operation via neighbor discovery; or
identifying the plurality of neighbor APs are present in a ImmW beacon report from a second client device and a ImmW beacon report of the serving AP.

18. The non-transitory computer-readable medium of claim 15, the method executed by the set of instructions further comprising:
determining angular differences between the beam directions from the serving AP toward the plurality of neighbor APs and the beam direction from the serving AP to the client device; and
wherein the management frame includes the angular differences.

19. The non-transitory computer-readable medium of claim 15, wherein the client device is configured to determine a target neighbor AP of the plurality of neighbor APs for roaming based on the antenna ID values for the plurality of neighbor APs and the antenna ID value for the client device.

20. The non-transitory computer-readable medium of claim 15, wherein the management frame is a reduced neighbor report (RNR).
